(19) United States
(12) Patent Application Publication
(10) Pub. No.: US 2026/0208279 A1
(43) Pub. Date: Jul. 23, 2026

(54) Method for Producing a Folded Flat Tube

(71) Applicant: MAHLE INTERNATIONAL GMBH, Stuttgart (DE)

(72) Inventors: Krzysztof OBSADNY, Raszkow (PL); Pawel RACHWALSKI, Ostrow Wielkoposki (PL); Marcin KUNZ, Ostrzeszow (PL)

(21) Appl. No.: 19/132,222

(22) PCT Filed: Jan. 15, 2024
(86) PCT No.: PCT/EP2024/050757

§ 371 Date: May 22, 2025

(30) Foreign Application Priority Data
Feb. 22, 2023 (DE) 10 2023 201 550.1

(51) Int. Cl. B23K 1/00; B23K 101/06; B23K 101/14; F28F 1/02

(52) U.S. Cl. CPC B23K 1/0012; F28F 1/02; B23K 2101/06; B23K 2101/14; F28F 2275/045

(57) ABSTRACT

A method for producing a folded flat tube is provided, wherein—the flat tube is folded, and a fluxing agent is supplied to the flat tube solely from the outside, the folding geometry being designated such that the fluxing agent reaches defined soldering locations during a subsequent soldering process but does not however reach the interior of the flat tube or only a quantity of fluxing agent reaches the interior which is less than a defined threshold quantity, or—the flat tube is folded and adhesive is supplied to the flat tube solely from the outside, the folding geometry being designated such that the adhesive reaches defined adhesion locations during a subsequent adhesion process but does not however reach the interior of the flat tube or only a quantity of adhesive reaches the interior which is less than a defined threshold quantity. In this manner, a quick and reliable but above all clean production of the flat tube is achieved.

### CROSS-REFERENCE TO RELATED APPLICATIONS

This application is a US National Stage Application under Section 371 of PCT Application No. PCT/EP2024/050757, filed on Jan. 15, 2024, which claims priority from German Patent Application No. DE 10 2023 201 550.1, filed on Feb. 22, 2023, the entirety of each is hereby incorporated by reference herein.

The present invention relates to a method for the production of a folded flat tube. The invention also relates to a flat tube produced with this method and a heat exchanger containing at least one such flat tube.

Flat tubes are used in a variety of ways in heat exchangers, e.g. coolant coolers in motor vehicles, and have proven to be effective for many years. Folded flat tubes are often used, e.g. made of aluminum, with which a profile can be produced containing numerous chambers, that also has an optimal weight. To be able to reliably seal such a folded flat tube, it is brazed in a brazing furnace after a flux has been applied to ensure that the brazing compound reliably reaches all of the points that are to be brazed, such that a reliable bond can be obtained. So-called controlled atmosphere brazing (CAB) methods can be used for this, in which a non-corrosive flux is used. In addition to ensuring that a reliable bond is obtained, the flux also cleans the surface where the brazing takes place, dissolving an oxide layer prior to the actual brazing, by means of which a reliable bond can be obtained.

The disadvantage with using flux is that it does not disappear or dissolve during the brazing process, and instead leaves crystallized flux residue on the surfaces that are to be brazed, e.g. the aluminum surfaces. If these surfaces are on the interior of a flat tube, for example, this can have a negative impact on the cleanliness in a subsequent finishing process, in particular for a customer, and in particular with heat exchangers that are to be used in fuel cell systems, substantially lengthening a passivation process. With current conventional methods for the production of flat tubes, the flux is applied to the flat tube that is to be produced during the folding process. Flux is also applied to the entire flat tube prior to the actual brazing in the brazing furnace. Only applying flux to the flat tube from the outside does not ensure that flux will be reliably applied to all of the brazing points with the prior cross section designs for flat tubes that are to be brazed, or that no flux, or only a tolerable amount of flux, will end up inside the flat tube. The same is also the case with folded and glued flat tubes.

The present invention therefore addresses the problem of finding a better, or at least different, method for the production of a folded flat tube, that resolves the problems of the prior art in particular.

This problem is solved with the invention by the subject matter of Numbered Paragraph 1. Advantageous embodiments are the subject matter of the Numbered Paragraphs that depend from Numbered Paragraph 1.

The present invention is based on the general idea of folding a flat tube, in particular for a heat exchanger, such that flux is only applied from the outside after the actual folding process, and it can be subsequently brazed in a brazing furnace, without fear of flux and other contaminants ending up inside the flat tube, and eventually in a coolant transporting system. The formulation, that no flux is to end up inside the flat tube, is to be understood to mean that any flux ending up in the flat tube is so little that it has no negative effect, or only a tolerable effect on a later finishing process, or later use of the flat tube, in particular in a heat exchanger. This also applies to a folded and subsequently glued flat tube. With the method obtained with the invention, the flat tube is first folded and flux is subsequently applied from the outside, wherein the folding geometry is such that the flux ends up at predefined brazing points in a subsequent brazing process, but not inside the flat tube, or only inside to an insignificant extent. In the case of a folded and glued flat tube, the flat tube can first be folded, and adhesive can then be applied only from the outside, wherein the folding geometry is such that the adhesive ends up at predefined gluing points in a subsequent gluing process, by not inside the flat tube, or only inside to an insignificant extent. Decisive for these alternatives of the method obtained with the invention is therefore that the folding geometry is such that flux or adhesive can be applied to the flat tube exclusively from the outside, and in a subsequent brazing or gluing process, an intolerable amount of flux or adhesive does not end up inside the flat tube. This keeps the inside of the flat tube extremely clean in comparison to previous production methods, resulting in no, or only tolerable amounts, of flux or adhesive residues, significantly simplifying further processing and use, in particular in a fuel cell system. As a result of the folding geometry obtained with the invention, it can nevertheless be ensured that the flux or adhesive will spread and consequently result in reliable brazed or glued bonds. Furthermore, by folding the flat tube and subsequently applying flux or adhesive, the production process can be quicker and more reliable, thus having a positive effect on the production costs and quality.

In another version of the production process obtained with the invention, the flat tube is folded such that at least one first brazing point or first gluing point is accessible from a first side of the flat tube, while a second brazing point or gluing point is accessible from a second, opposite side of the flat tube. This makes it possible to obtain two brazing or gluing points on opposite sides, to which flux or adhesive can be applied exclusively from the outside. It is also conceivable to fold the flat tube such that two first brazing or gluing points are accessible from a first side of the flat tube, while a second brazing or gluing point is accessible from the second, opposite side of the flat tube. It is possible to design the folding geometry of the flat tube such that a double-layered middle web is obtained, to which an edge of part of a flat tube is to be brazed or glued.

In another advantageous version of the method obtained with the invention, the flat tube is folded such that a single-layered middle web is obtained, which has a first brazing or gluing point on a first side, and a second brazing or gluing point on a second, opposite side. This makes it possible to separate two adjacent chambers of the flat tube with a single-layered middle web, allowing for efficient heat exchange, due to the limited thickness. By bonding a first edge on the first side of the middle web and a second edge on the second side of the middle web, the flat tube obtained with the invention can be produced with just two brazing or gluing bonds, which results in a significantly more efficient and therefore less expensive production process.

In a particularly preferred version of the method obtained with the invention, the flat tube is folded such that the middle web is straight, diagonal, or s-shaped. A diagonal or s-shaped single-layered middle web results in a larger surface area between the two adjacent chambers of the flat tube, and thus better heat exchange. An s-shaped, diagonal, or straight middle web also advantageously reinforces the flat tube obtained with the invention.

In another advantageous version of the method obtained with the invention, the flat tube is folded such that a double-layered middle web is obtained, with a first brazing or gluing point on one side, and a second brazing or gluing point on the other, opposite side. This results in a particularly stiff flat tube in which the double-layered middle web is brazed or glued from the first side of the flat tube, while the two edges of the flat tube segment are bonded, i.e. brazed or glued, on the other side of the flat tube to the two opposite sides of the middle web. With this version, it is still possible to make the fold and subsequently apply flux exclusively from the outside, resulting in a more efficient and less expensive production process.

The double-layered middle web has notches where it transitions to a wide side of the flat tube. These notches make it easier to fold the middle web, and thus simplify production of the flat tube.

In a particularly preferred version, the flat tube is folded such that the surface area of the contact between the middle web and the edge of the section of the flat tube that is to be brazed or glued thereto is relatively large. Compared to a linear contact, this results in a much stronger brazing or adhesive bond.

The invention is also based on the general concept of producing a flat tube with the method described above. The advantages obtained with the method are also obtained with the flat tube. These advantages are a more efficient and less expensive production and a significantly improved cleanliness, in particular inside the flat tube, benefitting subsequent finishing steps and subsequent use, in particular in a fuel cell system.

The present invention is also based on the general concept of equipping a heat exchanger with at least one flat tube described above and produced with the method obtained with the invention, thus obtaining the advantages described in reference to the flat tube for the heat exchanger.

Other important features and advantages of the invention can be derived from the dependent claims, drawings, and the descriptions of the drawings.

It is understood that the features described above and explained below can be used not only in the respective combinations specified herein, but also in other combinations or in and of themselves, without abandoning the scope of the invention. Components of a higher order unit specified herein, e.g. an apparatus, device, or assembly, that are indicated separately, can form separate components or parts of this unit, or be integral parts or sections of this unit, even if the drawings indicate otherwise.

Preferred exemplary embodiments of the invention are shown in the drawings, and shall be explained in greater detail below, in which the same reference symbols are used for identical, similar, or functionally identical components.

Therein, schematically:

FIG. 1 shows a cross sectional view and a detail view of a flat tube produced in accordance with the invention;

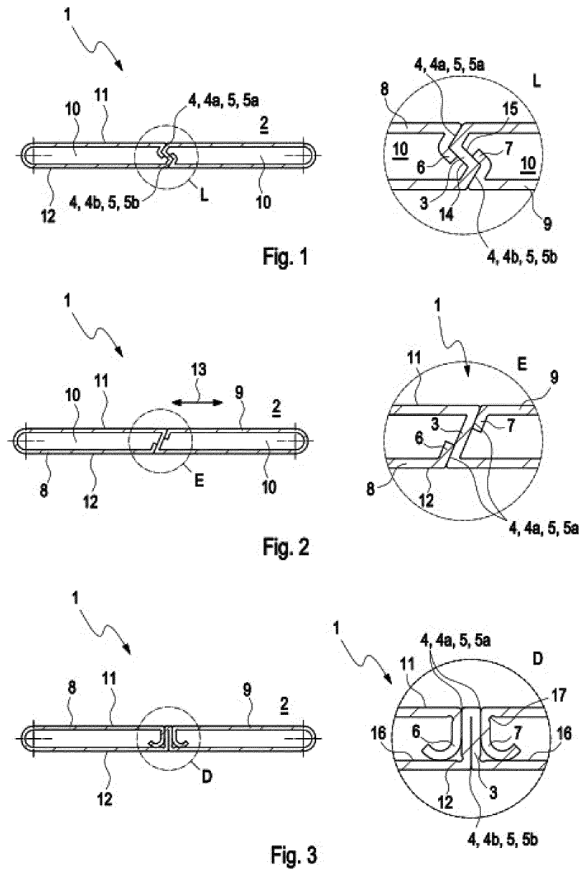

FIG. 2 shows a cross-section and a detail view of a different folding geometry shown in FIG. 1.

FIG. 3 shows a cross-section and a detail view of a different folding geometry shown in FIG. 1.

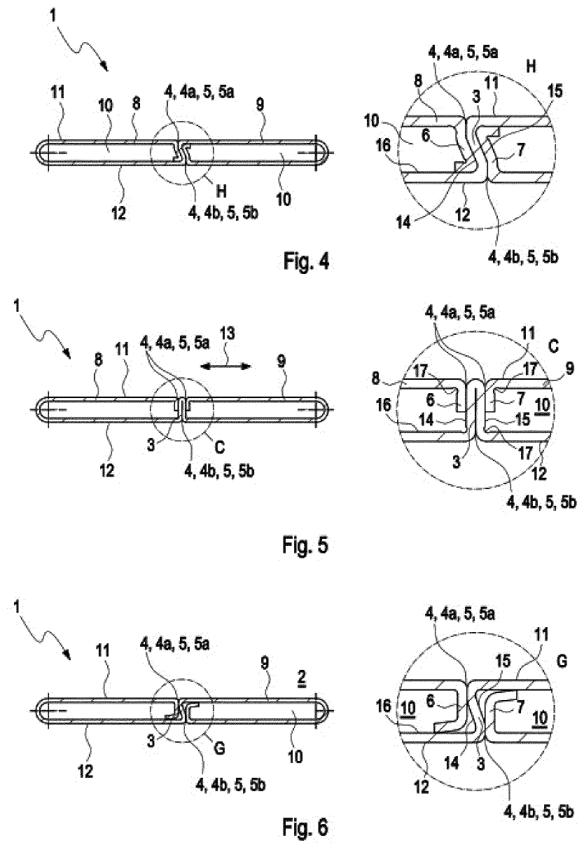

FIG. 4 shows a cross-section and a detail view of a different folding geometry shown in FIG. 1.

FIG. 5 shows a cross-section and a detail view of a different folding geometry shown in FIG. 1.

FIG. 6 shows a cross-section and a detail view of a different folding geometry shown in FIG. 1.

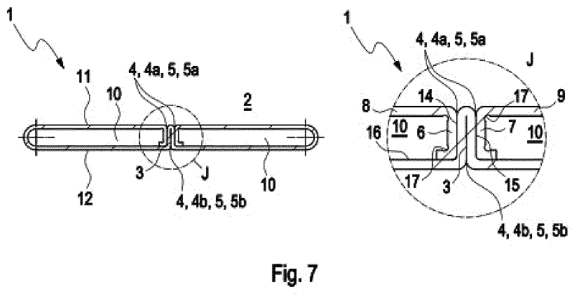

FIG. 7 shows a cross-section and a detail view of a different folding geometry shown in FIG. 1.

FIGS. 1 to 7 show a flat tube 1 obtained with the invention, which can be used in a heat exchanger 2, in particular in a motor vehicle or fuel cell. The flat tube 1 has a middle web 3, which either has a single layer, as shown in FIGS. 1, 2, 4 and 6, or two layers, as shown in FIGS. 3, 5 and 7. Edges 6, 7 of an associated flat tube segment 8, 9 are brazed or glued to the middle web 3 at corresponding brazing points 4, 4a, 4b or gluing points 5, 5a, 5b. The middle web 3 can be straight, as shown in FIGS. 3, 5 and 7, or diagonal, as shown in FIGS. 2, 4, and 6, or s-shaped or z-shaped, as shown in FIG. 1.

The flat tube 1 obtained with the invention is produced in a method obtained with the invention, which is explained below:

The flat tube 1 is first folded, after which flux is applied to it, exclusively from the outside, wherein the folding geometry that is used is such that the flux ends up at predefined brazing points 4, 4a, 4b in a subsequent brazing process, but not, or only to a limited extent, in the interior 10 of the flat tube 1. In an alternative version of the production process obtained with the invention, the flat tube 1 is also first folded, after which adhesive is applied exclusively from the outside, wherein the flat tube 1 is also folded such that the adhesive ends up at predefined gluing points 5, 5a, 5b, but not, or only to a limited extent, in the interior 10 of the flat tube 1.

It is therefore possible with the method obtained with the invention, to avoid applying flux to both the inside and outside of the flat tube 1, significantly improving the cleanliness of the interior 10 of the flat tube 1. This also has a positive effect on a passivation process. Furthermore, the flat tube 1 produced with the invention can be transferred to a subsequent finishing process in a significantly cleaner state, thus reducing the cleaning process, or even entirely eliminating it. This also results in a better bond at the brazing points 4, 4a, 4b or gluing points 5, 5a, 5b, and therefore a reliable and sealed flat tube 1. By not applying the flux or adhesive during the folding process, the tube can be shaped significantly more quickly and effectively. This also reduces the amount of flux or adhesive that is needed, thus lowering production costs.

In an advantageous version of the method obtained with the invention, the flat tube 1 is folded such that a first brazing point 4a or first gluing point 5a can be accessed from a first side 11 of the flat tube 1, while a second brazing point 4b or gluing point 5b can be accessed from a second, opposite side 12 of the flat tube 1 (see FIGS. 1 to 7).

The flat tube 1 shown in FIGS. 1, 2 and 6 has just one brazing point 4 or gluing point 6 on the first side 11, and on the second side 12. The flat tube 1 shown in FIG. 3, and 5-7 is folded such that two first brazing points 4a or two first gluing points 5a can be accessed from the first side 11, while only one second brazing point 4b or second gluing point 5b can be accessed from the second side 12.

The second brazing point 4b or second gluing point 5b is between the two first brazing points 4a or gluing points 5a in the lateral direction 13.

Looking at just FIG. 1, it is clear that the zig-zag-shaped middle web 3 is bonded, e.g. brazed or glued, on a first side 14 to the first edge 6 of the flat tube segment 8, while the middle web 3 is glued or brazed on the second side 15 to the edge 7 of the flat tube segment 9.

Between the edges 6, 7 and the associated sides 14, 15 of the middle web 3, the contact is preferably over a large flat surface area, significantly improving the brazed or glued bond. This is the case with all of the embodiments shown in FIGS. 1 to 7.

In FIG. 3, the flat tube 1 obtained with the invention has a double-layered middle web 3, which is also straight. The two edges 6, 7 bear on the opposing sides 14, 15 of the middle web 3 and on an inner surface 16 of the flat tube 1. The edges 6, 7 can also be bonded here at a brazing point 4 or gluing point 5, but this is not necessary. This is also the case with the embodiments in FIGS. 4, 6 and 7.

The embodiment of the flat tube 1 shown in FIG. 5 shows that the edges 6, 7 have notches 17, as does the middle web 3, thus simplifying the folding process.

On the whole, a flat tube 1 can be obtained with this process more easily and less expensively, as well as more quickly. This also significantly improves the cleanliness of the interior 10 of the flat tube 1, eliminating, or at least reducing, the need for subsequent cleaning, and ensuring a reliable use of the flat tube 1, e.g. in a heat exchanger 2. The flat tube 1 can be made of aluminum, and the flux can be a CAB flux. It is also possible to use an adhesive.

This specification can be readily understood with reference to the following Numbered Paragraphs:

Numbered Paragraph 1. A method for the production of a folded flat tube (1), characterized in that
the flat tube (1) is folded, and flux is applied exclusively from the outside, wherein the folding geometry is such that the flux ends up at predefined brazing points (4, 4a, 4b) in a subsequent brazing process, but not, or only to a limited extent, in the interior (10) of the flat tube (1), or
the flat tube (1) is folded, and adhesive is applied exclusively from the outside, wherein the folding geometry is such that the adhesive ends up at predefined gluing points (5, 5a, 5b) in a subsequent gluing process, but not, or only to a limited extent, in the interior (10) of the flat tube (1).

Numbered Paragraph 2. The method according to Numbered Paragraph 1, characterized in that the flat tube (1) is folded such that at least one first brazing point (4a) or one first gluing point (5a) is accessible from a first side (11) of the flat tube (1), while a second brazing point (4b) or gluing point (5b) is accessible from a second, opposite side (12) of the flat tube (1).

Numbered Paragraph 3. The method according to Numbered Paragraph 1 or 2, characterized in that the flat tube (1) is folded such that two first brazing points (4a) or two first gluing points (5a) are accessible from a first side (11) of the flat tube (1), while a second brazing point (4b) or second gluing point (5b) is accessible from a second, opposite side (12) of the flat tube (1), or vice versa.

Numbered Paragraph 4. The method according to Numbered Paragraph 3, characterized in that the flat tube (1) is folded such that the second brazing point (4b) or second gluing point (5b) is between the two first brazing points (4a) or gluing points (5a) in the lateral direction (13).

Numbered Paragraph 5. The method according to any of the preceding Numbered Paragraphs, characterized in that the flat tube (1) is folded such that a single-layered middle web (3) is obtained, which has first brazing point (4a) or first gluing point (5a) on a first side (14), and a second brazing point (4b) or second gluing point (5b) on an opposite second side (15) of the middle web (3).

Numbered Paragraph 6. The method according to Numbered Paragraph 5, characterized in that the flat tube (1) is folded such that the middle web (3) is straight, diagonal, s-shaped, or z-shaped.

Numbered Paragraph 7. The method according to any of the Numbered Paragraphs 1 to 4, characterized in that the flat tube (1) is folded such that a double-layered middle web (3) is obtained, with a first brazing point (4a) or first gluing point (5a) on a first side (14) and a second brazing point (4b) or gluing point (5b) on an opposite second side (15) of the middle web (3).

Numbered Paragraph The method according to Numbered Paragraph 7, characterized in that the double-layered middle web (3) has notches (17) at the transitions to wide sides of the flat tube (1).

Numbered Paragraph 9. The method according to any of the preceding Numbered Paragraphs, characterized in that the flat tube (1) is folded such that a large surface area contact is obtained between the middle web (3) and the edges (6, 7) that are to be brazed or glued at the brazing points (4, 4a, 4b) or gluing points (5, 5a, 5b).

Numbered Paragraph 10. A flat tube (1) produced according to the method in any of the preceding Numbered Paragraphs.

Numbered Paragraph 11. A heat exchanger (2) that has a flat tube (1) according to Numbered Paragraph 10.

1. A method for the production of a folded flat tube (1), characterized in that
the flat tube (1) is folded, and flux is applied exclusively from the outside, wherein the folding geometry is such that the flux ends up at predefined brazing points (4, 4a, 4b) in a subsequent brazing process, but not, or only to a limited extent, in the interior (10) of the flat tube (1), or
the flat tube (1) is folded, and adhesive is applied exclusively from the outside, wherein the folding geometry is such that the adhesive ends up at predefined gluing points (5, 5a, 5b) in a subsequent gluing process, but not, or only to a limited extent, in the interior (10) of the flat tube (1).

2. The method according to claim 1, characterized in that the flat tube (1) is folded such that at least one first brazing point (4a) or one first gluing point (5a) is accessible from a first side (11) of the flat tube (1), while a second brazing point (4b) or gluing point (5b) is accessible from a second, opposite side (12) of the flat tube (1).

3. The method according to claim 1 or 2, characterized in that the flat tube (1) is folded such that two first brazing points (4a) or two first gluing points (5a) are accessible from a first side (11) of the flat tube (1), while a second brazing point (4b) or second gluing point (5b) is accessible from a second, opposite side (12) of the flat tube (1), or vice versa.

4. The method according to claim 3, characterized in that the flat tube (1) is folded such that the second brazing point (4b) or second gluing point (5b) is between the two first brazing points (4a) or gluing points (5a) in the lateral direction (13).

5. The method according to any of the preceding claims, characterized in that the flat tube (1) is folded such that a single-layered middle web (3) is obtained, which has first brazing point (4a) or first gluing point (5a) on a first side (14), and a second brazing point (4b) or second gluing point (5b) on an opposite second side (15) of the middle web (3).

6. The method according to claim 5, characterized in that the flat tube (1) is folded such that the middle web (3) is straight, diagonal, s-shaped, or z-shaped.

7. The method according to any of the claims 1 to 4, characterized in that the flat tube (1) is folded such that a double-layered middle web (3) is obtained, with a first brazing point (4a) or first gluing point (5a) on a first side (14) and a second brazing point (4b) or gluing point (5b) on an opposite second side (15) of the middle web (3).

8. The method according to claim 7, characterized in that the double-layered middle web (3) has notches (17) at the transitions to wide sides of the flat tube (1).

9. The method according to any of the preceding claims, characterized in that the flat tube (1) is folded such that a large surface area contact is obtained between the middle web (3) and the edges (6, 7) that are to be brazed or glued at the brazing points (4, 4a, 4b) or gluing points (5, 5a, 5b).

10. A flat tube (1) produced according to the method in any of the preceding claims.

11. A heat exchanger (2) that has a flat tube (1) according to claim 10.

12. A method for the production of a folded flat tube, wherein
the flat tube is folded, and flux is applied exclusively from an outside of the folded flat tube, wherein a geometry of the folded flat tube is such that the flux is present at predefined brazing points in a subsequent brazing process, but not, or only to a limited extent, in an interior portion of the flat tube, or
the flat tube is folded, and adhesive is applied exclusively from an outside of the folded flat tube, wherein the folding geometry of the folded flat tube is such that the adhesive is present at predefined gluing points in a subsequent gluing process, but not, or only to a limited extent, in the interior portion of the flat tube.

13. The method according to claim 12, wherein the flat tube is folded such that at least one first brazing point or at least one first gluing point is accessible from a first side of the flat tube, while a second brazing point or a second gluing point is accessible from a second, opposite side of the flat tube.

14. The method according to claim 12, wherein the flat tube is folded such that two first brazing points or two first gluing points are accessible from a first side of the flat tube, and wherein a second brazing point or a second gluing point is accessible from a second, opposite side of the flat tube.

15. The method according to claim 14, wherein the flat tube is folded such that the second brazing point is between the two first brazing points in a lateral direction or the second gluing point is between the two first gluing points in the lateral direction.

16. The method according to any of claim 12, wherein the flat tube is folded such that a single-layered middle web is obtained, which has first brazing point or first gluing point on a first side, and a second brazing point or second gluing point on an opposite second side of the middle web.

17. The method according to claim 16, wherein the flat tube is folded such that the middle web is straight, diagonal, s-shaped, or z-shaped.

18. The method according to claim 12, wherein the flat tube is folded such that a double-layered middle web is obtained, with a first brazing point or first gluing point on a first side and a second brazing point or gluing point on an opposite second side of the middle web.

19. The method according to claim 18, wherein the double-layered middle web comprises notches in one or more positions where the middle web transitions to a wide sides of the flat tube.

20. The method according to claim 16, wherein the flat tube is folded such that a large surface area contact is obtained between the middle web and the edges that are to be brazed or glued at the brazing points or gluing points.

21. A flat tube produced according to the method of claim 12.

22. A heat exchanger comprising a flat tube according to claim 21.
